(19) United States
(12) Patent Application Publication
(10) Pub. No.: US 2008/0224950 A1
(43) Pub. Date: Sep. 18, 2008

(54) Computer program and apparatus for display control

(75) Inventors: Fumiyuki Hashimoto, Kawasaki (JP); Yoshiyuki Okada, Kawasaki (JP); Yoshiaki Kageyama, Inagi (JP); Shinobu Tamura, Inagi (JP); Rumiko Matsuda, Kawasaki (JP); Koji Sato, Kawasaki (JP); Shigenori Sasaki, Kawasaki (JP)

Correspondence Address: STAAS & HALSEY LLP, SUITE 700, 1201 NEW YORK AVENUE, N.W., WASHINGTON, DC, 20005, US

(73) Assignees: FUJITSU LIMITED, Kawasaki (JP); FUJITSU FRONTECH LIMITED, Tokyo (JP)

(21) Appl. No.: 12/076,121

(22) Filed: Mar. 13, 2008

(30) Foreign Application Priority Data
Mar. 16, 2007 (JP) 2007-068065

(51) Int. Cl. G09G 5/00

(52) U.S. Cl. 345/1.3

(57) ABSTRACT

A computer program and apparatus for display control, which are capable of allowing a user to easily know the positional relationships among a plurality of display devices in the case where he/she uses the plurality of display devices to display content. An area information memory stores information on the display areas of display devices. An identification information memory stores a plurality of identification information. When information including the number of display devices to be used and content to be displayed is entered, a creating unit creates display data so as to match an entire usable display area. A dividing unit divides the display data into a plurality of partial display data according to the display areas of the display devices, and adds identification information to sides that are adjacent to other partial display data, out of the sides of the plurality of partial display data. An output unit outputs the obtained partial display data to the display devices.

### CROSS-REFERENCE TO RELATED APPLICATIONS

This application is based upon and claims the benefits of priority from the prior Japanese Patent Application No. 2007-068065 filed on Mar. 16, 2007, the entire contents of which are incorporated herein by reference.

### BACKGROUND OF THE INVENTION

(1) Field of the Invention

The present invention relates to a computer program and apparatus for display control, and more particularly to a display control program and apparatus for displaying content on a plurality of display devices.

(2) Description of the Related Art

With drastic improvement in the technology for manufacturing display devices that display letters and images, various kinds of display devices have been developed. Among them, so-called electronic paper is attracting much attention as a paper-like thin display device that has nonvolatile characteristics allowing it to retain displayed contents even if power is turned off. Electronic papers have good portability and can be arranged over a desk or anywhere. Therefore, electronic papers are expected as electronic devices that encourage human's free thinking activity (for example, refer to Japanese Unexamined Patent Publication No. 2006-31373).

Portable display devices, like electronic paper, are restricted in display size from the point of view of user-friendliness. For example, it is desired that display devices can be put into bags to carry to outside. It is also desired that content that requires a big display size, like a wide area map, can be stored in display devices and carried.

For these purposes, one known technique allows content that requires a big display size to be divided and displayed on a plurality of display devices (for example, refer to Japanese Unexamined Patent Publication No. 2004-286952). Dividing content allows a user to carry and see the content by storing it in a plurality of display devices together and arranging the display devices over a desk.

However, the technique taught in Japanese Unexamined Patent Publication No. 2004-286952 has a drawback that it is not easy to set the plurality of display devices in correct arrangement. A user has to repeatedly arrange the display devices to see the content while seeing the screens of the display devices until he/she finds out the correct arrangement. If one image like a map is divided without taking semantic relevance into consideration, for example, the user should guess the continuity of screens while checking the sides of the screens. Therefore, the user should work hard to prepare for seeing the content.

### SUMMARY OF THE INVENTION

This invention has been made in view of foregoing and intends to provide a computer program and apparatus for display control that allow the positional relationships among a plurality of display devices to be easily known when content is displayed on the display devices.

To accomplish the above object, there is provided a computer-readable recording medium containing a display control program for displaying content on a plurality of display devices. The display control program causes a computer to operate as: an area information memory storing information on display areas of the plurality of display devices; an identification information memory storing a plurality of identification information; a creating unit for consulting the area information memory to specify an entire usable display area and creating display data so as to match the entire usable display area when information specifying a number of display devices to be used and content to be displayed is entered; a dividing unit for dividing the display data created by the creating unit into a plurality of partial display data according to the display areas of the display devices and adding one of the plurality of identification information stored in the identification information memory, to a side of partial display data out of the sides of the plurality of partial display data, the side adjacent to another partial display data; and an output unit for outputting the plurality of partial display data obtained by the dividing unit, to the display devices.

Further, to accomplish the above object, there is provided a display control apparatus for displaying content on a plurality of display devices. The display control apparatus comprises: an area information memory storing information on display areas of the plurality of display devices; an identification information memory storing a plurality of identification information; a creating unit that consults the area information memory to specify an entire usable display area and creates display data so as to match the entire usable display area when information specifying a number of display devices to be used and content to be displayed is entered; a dividing unit that divides the display data created by the creating unit into a plurality of partial display data according to the display areas of the display devices and adds one of the plurality of identification information stored in the identification information memory, to a corner of partial display data out of corners of the plurality of partial display data, the corner sandwiched between two other pieces of partial display data; and an output unit that outputs the plurality of partial display data obtained by the dividing unit, to the display devices.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows an outline of one embodiment.

FIG. 2 shows a system configuration according to the first embodiment.

FIG. 3 shows a hardware configuration of a mobile telephone.

FIG. 4 shows a hardware configuration of a WWW server.

FIG. 5 is a functional block diagram of a mobile telephone according to the first embodiment.

FIG. 6 shows an explanatory data structure of a display area table.

FIG. 7 shows an explanatory data structure of an identification information table.

FIG. 8 schematically shows divisions of display data.

FIG. 9 shows an explanatory data structure of an identification position table according to the first embodiment.

FIG. 10 is a flowchart showing a procedure of a display process according to the first embodiment.

FIG. 11 shows an explanatory entry screen to be displayed on a mobile telephone.

FIG. 12 shows explanatory display screens of electronic papers according to the first embodiment.

FIG. 13 shows the system configuration according to the second embodiment.

FIG. 14 is a functional block diagram of a mobile telephone according to the second embodiment.

FIG. 15 is a flowchart showing a procedure of a display process according to the second embodiment.

FIG. 16 shows an explanatory output process screen to be displayed on a mobile telephone.

FIG. 17 is a functional block diagram of a mobile telephone according to the third embodiment.

FIG. 18 is an explanatory data structure of an identification position table according to the third embodiment.

FIG. 19 is a flowchart showing a procedure of a display process according to the third embodiment.

FIG. 20 is an explanatory arrangement confirmation screen to be displayed on the mobile telephone.

FIG. 21 is explanatory display screens of electronic papers according to the third embodiment.

### DESCRIPTION OF THE PREFERRED EMBODIMENTS

Preferred embodiments of the present invention will be described with reference to the accompanying drawings. An outline of one embodiment and then the embodiments will be described in detail.

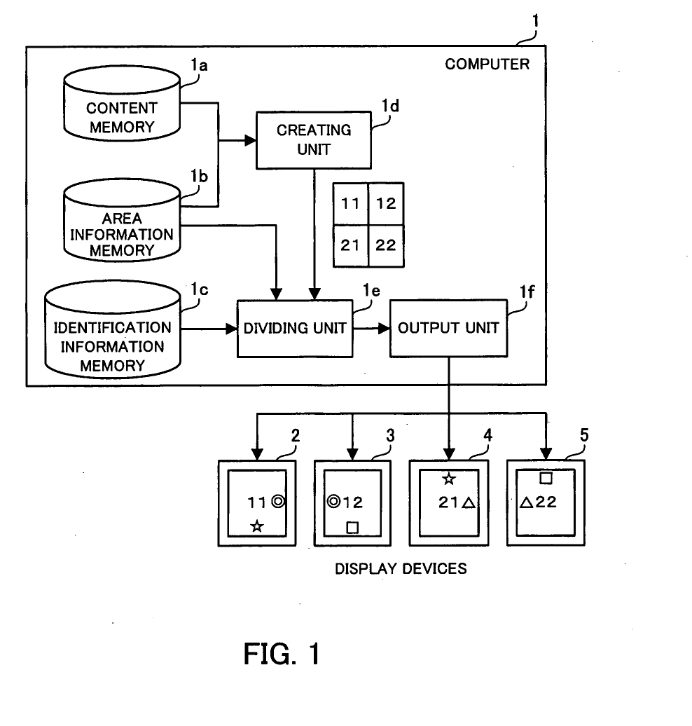

FIG. 1 shows an outline of one embodiment. As illustrated in FIG. 1, a computer 1 has a content memory 1a, an area information memory 1b, an identification information memory 1c, a creating unit 1d, a dividing unit 1e, and an output unit 1f. The output unit if is connected to display devices 2 to 5.

The content memory 1a stores the files of content to be displayed. The content is HyperText Markup Language (HTML) documents and still images, for example. In response to user inputs, the computer 1 stores the file of the specified content in the content memory 1a.

The area information memory 1b stores information on the display areas of the display devices 2 to 5. In more detail, information to be stored is the number of horizontal pixels and the number of vertical pixels in the display areas of the display devices 2 to 5. If it can be expected that some types of display devices are to be connected to the output unit 1f, information on the display areas of all of the types of display devices is stored in the area information memory 1b.

The identification information memory 1c stores a plurality of identification information. The identification information allows adjacent sides of the display devices 2 to 5 to be visually confirmed when the display devices 2 to 5 are arranged in a plane. Colors, patterns, codes, or letters are used as the identification information, for example.

The creating unit 1d receives user inputs and obtains information including the number of display devices to be used and content to be displayed. Then, the creating unit 1d acquires the file of the specified content from the content memory 1a. In addition, the creating unit 1d acquires information on the display areas of the display devices 2 to 5 from the area information memory 1b.

Then the creating unit 1d specifies the entire usable display area, and creates display data corresponding to the specified content so as to match the size of the entire display area. For example, if user inputs specify four display devices for use and the display devices 2 to 5 have the same display area size, the creating unit 1d creates display data that is vertically and horizontally twice as long as (that is, display data that has a size four times as large as) the display area of the display device 2 to 5.

When the creating unit 1d creates the display data, the dividing unit 1e divides the created display data into a plurality of partial display data according to the display areas of the display devices to be used. For example, assume that user inputs specify four display devices for use and the display devices 2 to 5 have the same display area size, the dividing unit 1e divides the display data into four pieces of partial display data by horizontally and vertically dividing the display data into halves.

Further, the dividing unit 1e acquires identification information from the identification information memory 1c and adds one piece of identification information to a side that is adjacent to another adjacent partial display data, out of the sides of the partial display data. For example, when the display data is divided into four pieces of partial display data as described above, the dividing unit 1e adds the identification information to the bottom and right sides of the upper-left partial display data, the bottom and left sides of the upper-right partial display data, the top and right sides of the lower-left partial display data, and the top and left sides of the lower-right partial display data.

In this connection, the identification information should be added so that adjacent sides can be visually confirmed easily. For example, same identification information is added to adjacent sides. In other words, different identification information is added to sides that are not adjacent to each other.

When the dividing unit 1e creates the plurality of partial display data, the output unit 1f selects display devices as many as the number of partial display data from among the display devices 2 to 5. Then the output unit 1f outputs one piece of partial display data to one display device. For example, if four pieces of partial display data are created, the output unit 1f outputs one piece of partial display data to each of the display device 2 to 5.

With such a computer 1, when information including the number of display devices to be used and content to be displayed is entered, the creating unit 1d specifies the entire usable display area and creates display data so as to match the entire display area. Then, the dividing unit 1e divides the created display data into a plurality of partial display data according to the display areas of the display devices 2 to 5, and adds identification information to sides that are adjacent to other partial display data, out of the sides of the partial display data. Then the output unit 1f outputs the finally obtained partial display data to at least some of the display devices 2 to 5.

Thereby, the desired content is divided and displayed on the display devices 2 to 5. When the user arranges the display devices 2 to 5 in a plane, he/she can easily know the correct arrangement of the display devices 2 to 5 based on the displayed identification information.

Now, the embodiments will be described in detail with reference to accompanying drawings.

### First Embodiment

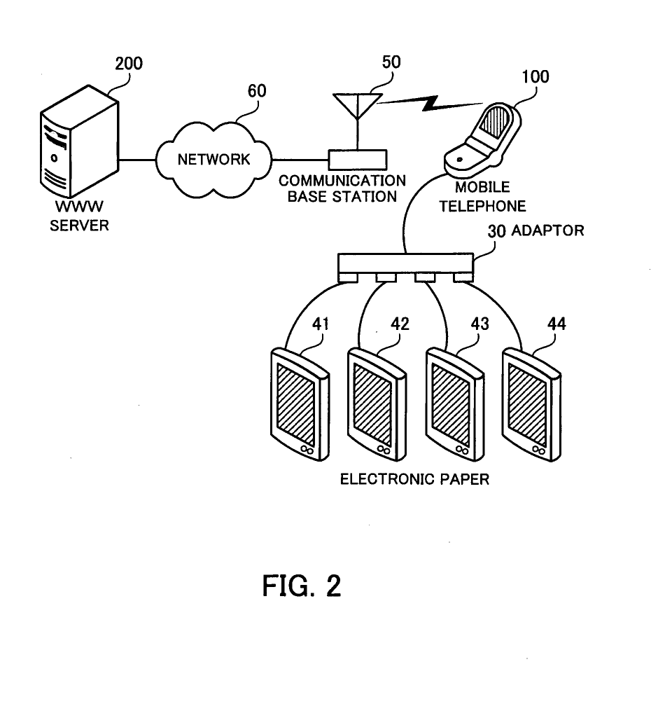

FIG. 2 shows a system configuration according to the first embodiment. In the content distribution system according to the first embodiment, a mobile telephone acquires content via a network from a World Wide Web (WWW) server, and divides and displays the content on a plurality of electronic papers.

A content distribution system shown in FIG. 2 comprises a mobile telephone 100, a WWW server 200, an adaptor 30, electronic papers 41 to 44, a communication base station 50 and a network 60. The WWW server 200 and the communication base station 50 are connected to the network 60 and are capable of communicating with each other. Further, the communication base station 50 and the mobile telephone 100 are capable of performing radio communications with each other. Connected to the mobile telephone 100 is the adaptor 30 to which four electronic papers 41 to 44 are connectable at the same time.

The electronic papers 41 to 44 are nonvolatile display devices that can retain displayed content even if power is turned off. When display data is input to the electronic papers 41 to 44 via the adaptor 30 from the mobile telephone 100, the electronic papers 41 to 44 display the contents of the data in their display areas. The displayed content is retained until another display data is input. It should be noted that the electronic papers 41 to 44 are relatively slow in display speed, and therefore they are not suitable for motion pictures. In the following description, it is assumed that the electronic papers 41 to 44 have the same display area size.

The mobile telephone 100 has an input unit, a small display unit, and an antenna for performing radio communications. In addition, the mobile telephone 100 has functions that general computers have, so as to execute prescribed programs. For example, the mobile telephone 100 is capable of acquiring and displaying content such as HTML documents and images from the WWW server 200 via the communication base station 50 and the network 60. In addition, the mobile telephone 100 is capable of acquiring and executing programs from the WWW server 200.

The WWW server 200 is a computer for storing and distributing content files and program files. When the WWW server 200 receives a file request via the network 60, it sends the specified file to a requesting source.

The following describes how a user of the mobile telephone 100 divides and displays content on the electronic papers 41 to 44. First, the user manipulates the mobile telephone 100 to acquire a program for controlling display of the electronic papers 41 to 44 from the WWW server 200. In addition, the user manipulates the mobile telephone 100 to acquire desired content to be displayed, from the WWW server 200.

Then, the user manipulates the mobile telephone 100 to start to execute the display control program and to specify desired content to be displayed and the number of electronic papers to be used for display. Then, the mobile telephone 100 creates display data corresponding to the specified content, and divides the display data according to the specified number of electronic papers. Then the mobile telephone 100 outputs the divided display data to at least some of the electronic papers 41 to 44. Thereby the desired content is divided and displayed on the plurality of electronic papers.

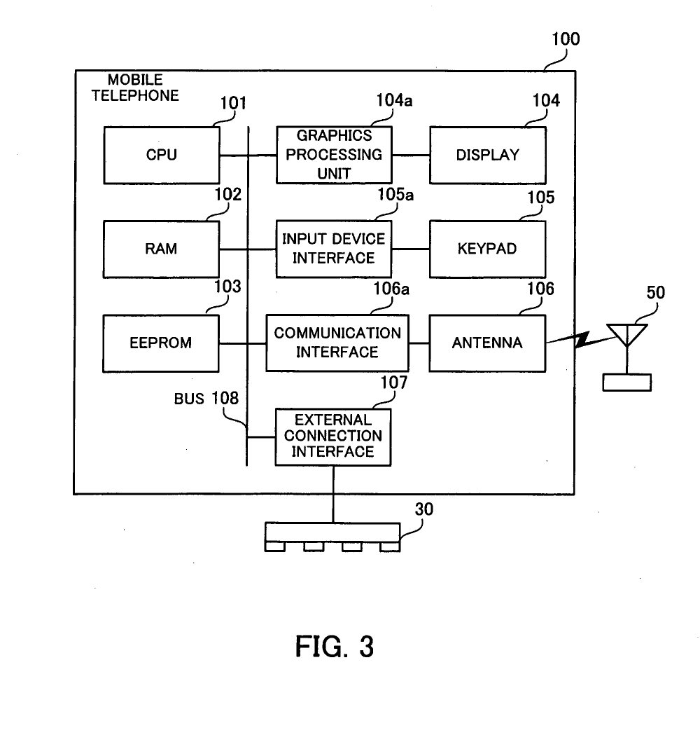

FIG. 3 shows a hardware configuration of a mobile telephone. The mobile telephone 100 is entirely controlled by a Central Processing Unit (CPU) 101. Connected to the CPU 101 via a bus 108 are a Random Access Memory (RAM) 102, Electronically Erasable and Programmable Read Only Memory (EEPROM) 103, a graphics processing unit 104a, an input device interface 105a, a communication interface 106a and an external connection interface 107.

The RAM 102 temporarily stores at least part of an Operating System (OS) program and application programs to be executed by the CPU 101. The RAM 102 also temporarily stores various kinds of data necessary for CPU processing.

The EEPROM 103 is a rewritable nonvolatile semiconductor memory such as a flash memory. The EEPROM 103 stores the OS program and application programs. The EEPROM 103 also stores various kinds of data that should be kept.

Connected to the graphics processing unit 104a is a display 104. The display 104 is a display device that is fast in display speed enough to display the contents of user inputs immediately. The graphics processing unit 104a displays images on the display 104 under the control of the CPU 101.

Connected to the input device interface 105a is a keypad 105. The keypad 105 is an input unit provided with input keys for numerals and alphabets, scroll keys for up, down, left, and right directions, an OK key for fixing processing contents, etc. The input device interface 105a transfers signals from the keypad 105 to the CPU 101 via the bus 108.

Connected to the communication interface 106a is an antenna 106. The antenna 106 searches for a communication base station within a radio wave footprint to perform radio communications with the communication base station. The communication interface 106a communicates data with another computer via the antenna 106.

The external connection interface 107 is an interface for communicating data with another device via a communication cable. Under the control of the CPU 101, the external connection interface 107 sends data to a device connected thereto, and transfers data from the device connected thereto to the CPU 101.

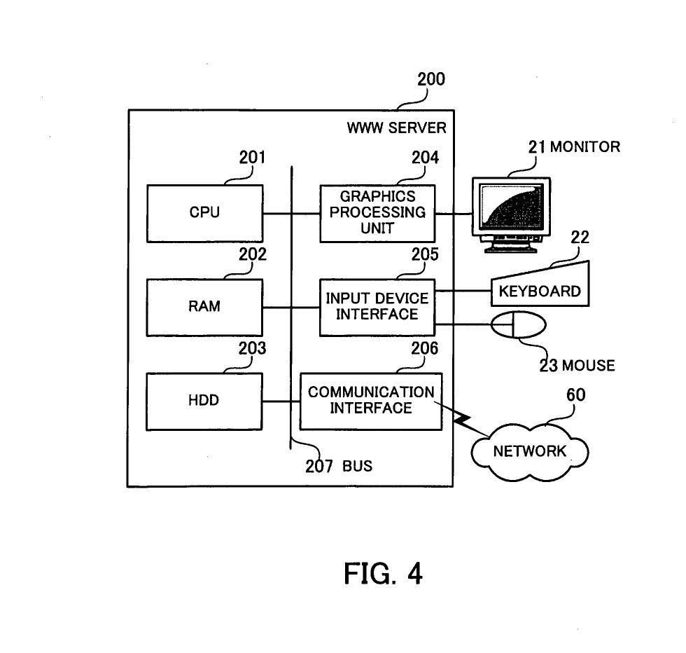

FIG. 4 shows a hardware configuration of a WWW server. The WWW server 200 is entirely controlled by a CPU 201. Connected to the CPU 201 via a bus 207 are a RAM 202, a Hard Disk Drive (HDD) 203, a graphics processing unit 204, an input device interface 205, and a communication interface 206.

The RAM 202 temporarily stores at least part of an OS program and application programs to be executed by the CPU 201. The RAM 202 also temporarily stores various kinds of data necessary for CPU processing. The HDD 203 stores the OS program, the application programs, and various kinds of data that should be kept.

Connected to the graphics processing unit 204 is a monitor 21 to display images thereon under the control of the CPU 201. Connected to the input device interface 205 are a keyboard 22 and a mouse 23, and is designed to transfer signals from the keyboard 22 and the mouse 23 to the CPU 201 via the bus 207.

The communication interface 206 is connected to the network 60. The communication interface 206 communicates data with another computer via the network 60.

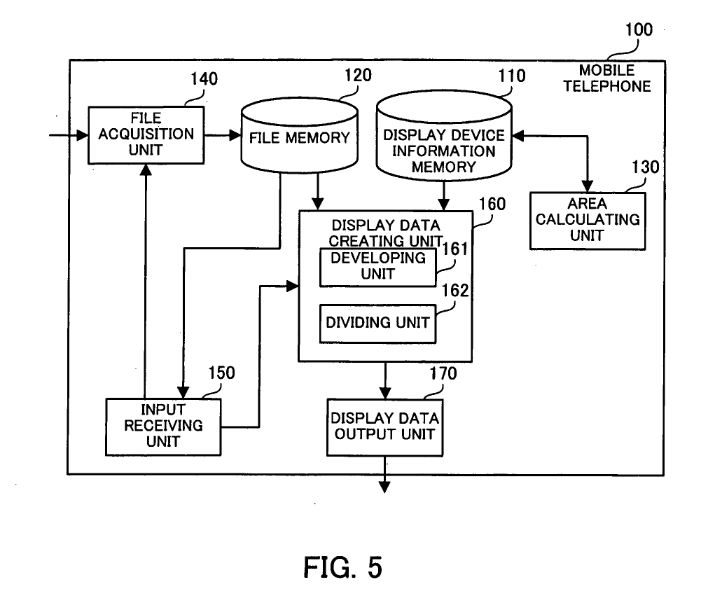

FIG. 5 is a functional block diagram of a mobile telephone according to the first embodiment. The mobile telephone 100 realizes the function modules shown in FIG. 5 by executing programs acquired from the WWW server 200. It should be noted that FIG. 5 does not illustrate functions other than functions relating to display control that the mobile telephone 100 has.

The mobile telephone 100 has a display device information memory 110, a file memory 120, an area calculating unit 130, a file acquisition unit 140, an input receiving unit 150, a display data creating unit 160, and a display data output unit 170.

The display device information memory 110 previously stores the display area information of electronic papers that may be connected to the mobile telephone 100. The display area information is information on the display areas of the electronic papers, including the number of horizontal pixels and the number of vertical pixels. In addition, the display device information memory 110 stores a list of usable identification information. The identification information is information that allows the correct arrangement of a plurality of electronic papers to be visually confirmed when content is divided and displayed on the electronic papers.

The file memory 120 stores the files of content such as HTML documents and images. The content files are stored by the file acquisition unit 140 when the need arises.

When a display control program is started, the area calculating unit 130 first confirms the types of electronic papers currently connected to the mobile telephone 100 via the adaptor 30. Then the area calculating unit 130 searches the display device information memory 110 for identification position information corresponding to the connected electronic papers. The identification position information is information that associates identification information with display positions. When identification position information is not found, the area calculating unit 130 creates identification position information based on the display area information of the connected electronic papers and the identification information, and stores it in the display device information memory 110.

When the file acquisition unit 140 receives a file request from the input receiving unit 150, it acquires the file of the specified content from the WWW server 200. Then the file acquisition unit 140 stores the acquired content file in the file memory 120.

The input receiving unit 150 detects user inputs made on the keypad 105. When the user inputs request acquisition of a file, the input receiving unit 150 sends a file request to the file acquisition unit 140. Thereby the file of the specified content is stored in the file memory 120.

When the user inputs request control of display on the electronic papers 41 to 44, the input receiving unit 150 displays a list of files stored in the file memory 120 on the display 140 so that the user can select desired content to be displayed. In addition, the input receiving unit 150 lets the user specify the number of electronic papers to be used and a display direction. When the user enters desired content to be displayed, the number of electronic papers to be used, and a display direction, the input receiving unit 150 gives the contents of the user inputs to the display data creating unit 160.

The display data creating unit 160 has a developing unit 161 and a dividing unit 162 as internal circuits. The display data creating unit 160 instructs the developing unit 161 and the dividing unit 162 to create display data to be displayed on the electronic papers 41 to 44, according to the input contents given from the input receiving unit 150.

The developing unit 161 acquires the file of the specified content from the file memory 120 and acquires the display area information of the connected electronic papers from the display device information memory 110. Then the developing unit 161 specifies the entire display area that is obtained by arranging the specified number of electronic papers in the specified display direction. Then the developing unit 161 develops the content so as to match the specified entire display area, thereby creating display data.

The dividing unit 162 divides the display data, which the developing unit 161 created, into a plurality of partial display data based on the number of electronic papers notified of from the input receiving unit 150 and the display area information stored in the display device information memory 110. Then the dividing unit 162 adds one piece of identification information to a side that is adjacent to another partial display data, out of the sides of the plurality of partial display data, based on the identification position information stored in the display device information memory 110. Then the dividing unit 162 outputs the obtained plurality of partial display data to the display data output unit 170.

When the display data creating unit 160 outputs the plurality of partial display data, the display data output unit 170 selects electronic papers as many as the number of partial display data, from among the electronic papers 41 to 44. Then the display data output unit 170 outputs one piece of partial display data to each of the electronic papers.

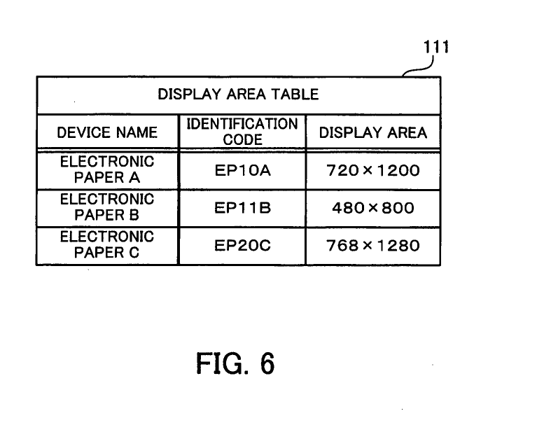

FIG. 6 shows an explanatory data structure of a display area table. The display area table 111 shown in FIG. 6 is stored in the display device information memory 110. The display area table 111 has columns for device name, identification code, and display area. Information arranged in a row is associated with each other to compose the display area information of one type of display device.

The device name column shows the type name of a display device. The identification code column shows a code uniquely assigned to one type of display device. The display area column shows values indicating the number of horizontal pixels and the number of vertical pixels.

Display area information to be stored in the display area table 111 is included in a program file acquired from the WWW server 200. When an electronic paper of new type is provided, only display area information can be additionally acquired from the WWW server 200 and registered in the display area table 111.

The example shown in FIG. 6 contains display area information comprising a device name of “electronic paper A”, an identification code of “EP10A”, and a display area of “720*1200”. Another display area information comprises a device name of “electronic paper B”, an identification code of “EP11B, and a display area of “480*800”. The other display area information comprises a device name of “electronic paper C”, an identification code of “EP20C”, and a display area of “768*1280”. It is assumed that all the electronic papers 41 to 44 are of type named “electronic paper A”.

The identification codes of electronic papers are used for determining the types of electronic papers connected to the mobile telephone 100. The mobile telephone 100 is capable of acquiring identification codes from the electronic papers 41 to 44 via the adaptor 30 and the external connection interface 107.

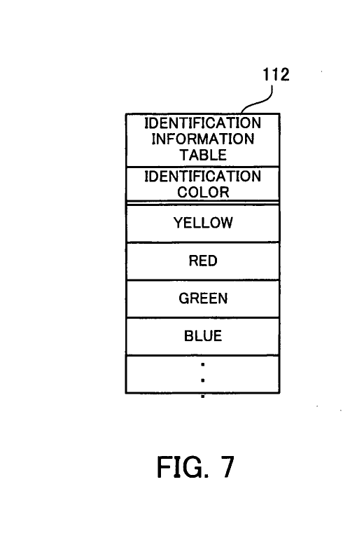

FIG. 7 shows an explanatory data structure of an identification information table. The identification information table is a table showing a list of usable identification information. The identification information table 112 shown in FIG. 7 is stored in the display device information memory 110. The identification information table 112 defines identification colors as identification information, by way of example. The identification information table 112 has a column for identification color. The identification color column shows a color such as “yellow”, “red”, green”, or “blue”.

Identification information to be stored in the identification information table 112 is included in a program file acquired from the WWW server 200. Only new identification information can be additionally acquired from the WWW server 200 and registered in the identification information table 112.

The display device information memory 110 stores identification position information of each type of electronic papers, in addition to the display area information and the identification information. The identification position information is created by the area calculating unit 130 based on the display area information and the identification information when the display control program is started.

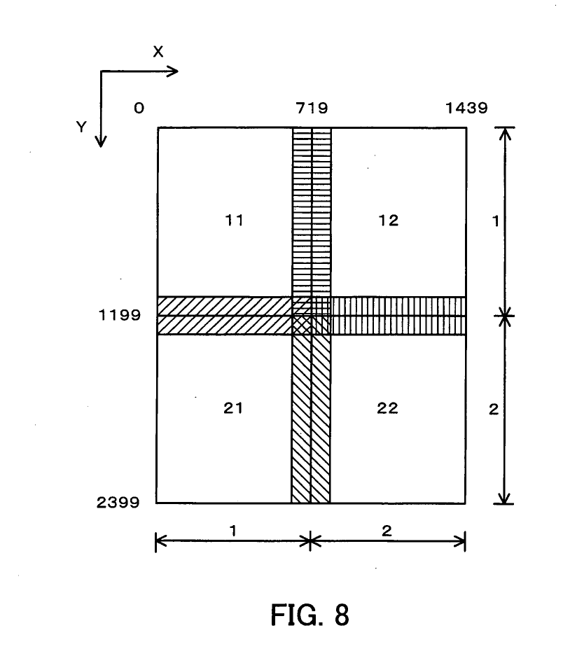

FIG. 8 schematically shows divisions of display data. The schematic view of FIG. 8 shows divided positions of display data and regions to which identification information is added, in the case where four electronic papers 41 to 44 are used in vertical direction.

Each of the four electronic papers 41 to 44 has a display area of 720 pixels*1200 pixels. Therefore, the entire display area of 1440 pixels*2400 pixels is usable. Therefore, when content is divided and displayed, display data of 1400 pixels*2400 pixels is first created.

Then, the created display data is divided into four pieces of partial display data. Now, two-dimensional coordinate space is considered, in which the upper-left point of the entire display area is taken to as (0, 0), and the lower-right point is taken to as (1439, 2399). The space is divided into two: 0 to 719 and 720 to 1439 in the horizontal direction (X-axis direction). The space is divided into two: 0 to 1199 and 1200 to 2399 in the vertical direction (Y-axis direction).

Then identification information is added to adjacent sides of adjacent partial display data. For example, each of the adjacent sides is colored in an identification color by 20 pixel width. In this case, in the two-dimensional coordinate space representing the entire display area, a region of pixels from 700 to 739 horizontal positions and a region of pixels from 1180 to 1219 vertical position are colored in an identification color. The identification position information defines correspondences between regions to which identification information are added and the added identification information.

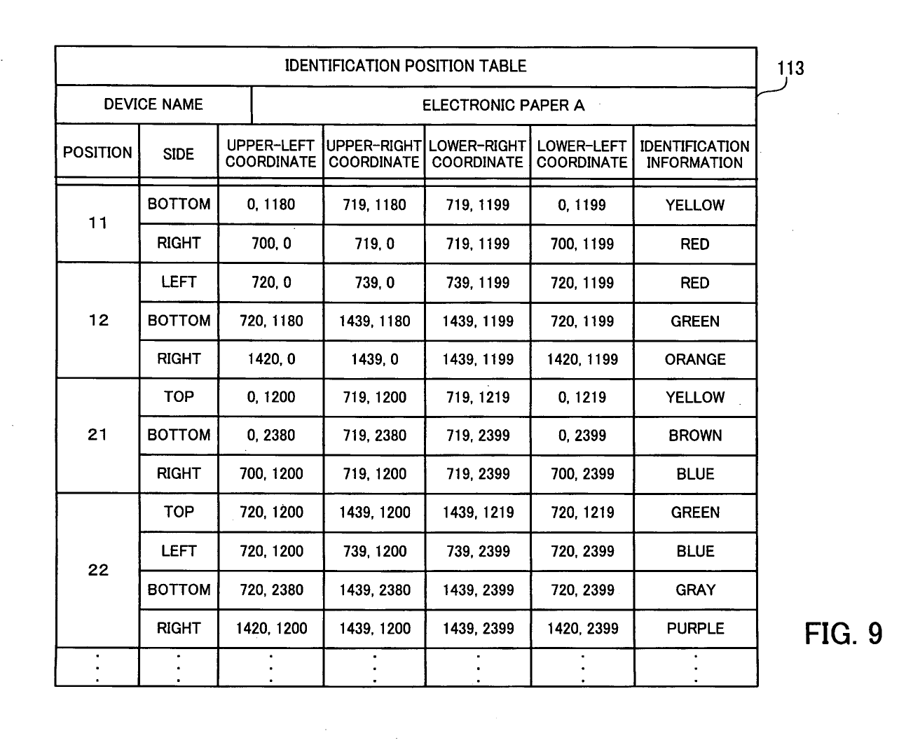

FIG. 9 shows an explanatory data structure of an identification position table according to the first embodiment. The identification position table 113 of FIG. 9 is a table storing identification position information of an electronic paper of type named “electronic paper A”. The identification position table 113 is stored in the display device information memory 110.

The identification position table 113 has columns for position, side, upper-left coordinate, upper-right coordinate, lower-right coordinate, lower-left coordinate, and identification information. Information arranged in a row is associated with each other to compose identification position information.

The position column shows a numerical value indicating the position of partial display data in an entire display area. The numerical value indicating a position comprises a two-digit integral number representing a horizontal position and a vertical position with the upper-left point of the entire display area as a reference. For example, a numerical value indicating the position of upper-left partial display data is “11” and a numerical value indicating the position of partial display data on the right side thereof is “12”.

The side column shows letters representing a side to which identification information is added. Specifically, one of “top”, “left”, “bottom”, and “right” is set.

The upper-left coordinate column shows numerical values representing the coordinate of the upper-left point of a region to which identification information is added.

The upper-right coordinate column shows numerical values representing the coordinate of the upper-right point of a region to which identification information is added. The lower-right coordinate column shows numerical values representing a coordinate of the lower-right point of a region to which identification information is added. The lower-left coordinate column shows numerical values representing the coordinate of the lower-left point of a region to which identification information is added.

The identification information column shows identification information to be added to a region specified by the other columns. The names of identification colors are set in the example of FIG. 9.

Identification position information to be stored in the identification position table 113 is registered by the area calculating unit 130 when the display control program is started. For example, information comprising a position of “11”, a side of “bottom”, an upper-left coordinate of “0, 1180”, an upper-right coordinate of “719, 1180”, a lower-right coordinate of “719, 1199”, a lower left coordinate of “0, 1199”, and identification information of “yellow” is registered. In the example of FIG. 9, the identification information of “yellow” is also set in association with the top side of the position “21” which is adjacent to the bottom side of the position “11”.

The following describes a display process to be performed in a system configured as described above and having the above-described data structures.

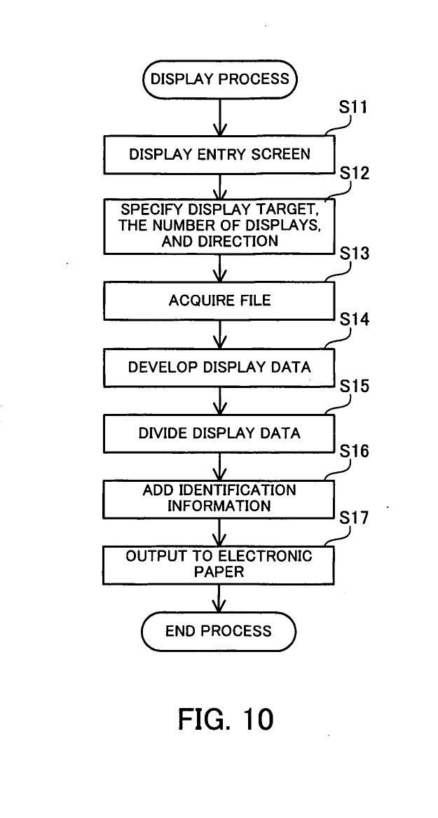

FIG. 10 is a flowchart showing a procedure of a display process according to the first embodiment. The procedure of FIG. 10 will be described step by step.

At step S11, the input receiving unit 150 acquires a list of stored files from the file memory 120. Then the input receiving unit 150 displays an entry screen on the display 104 for specifying a file storing content to be displayed, the number of electronic papers to be used for display, and a display direction (vertical or horizontal).

At step S12, the input receiving unit 150 receives user inputs made on the entry screen displayed at step S11, and specifies a file name, the number of electronic papers, and a display direction. Then the input receiving unit 150 gives the specified contents to the display data creating unit 160.

At step S13, the display data creating unit 160 instructs the developing unit 161 to create display data. The developing unit 161 acquires a file corresponding to the file name given from the input receiving unit 150, from the file memory 120.

At step S14, the developing unit 161 acquires the display area information of the electronic papers 41 to 44 from the display area table 111 stored in the display device information memory 110. Then the developing unit 161 specifies the entire usable display area based on the acquired display area information, and the number of electronic papers and the display direction given from the input receiving unit 150. Then the developing unit 161 develops the content so as to match the specified entire display area, thereby creating display data.

At step S15, the display data creating unit 160 instructs the dividing unit 162 to divide the display data. The dividing unit 162 divides the display data created by the developing unit 161 into a plurality of partial display data, based on the display area information of the electronic papers 41 to 44, and the number of electronic papers and the display direction given from the input receiving unit 150.

At step S16, the dividing unit 162 acquires the identification position information corresponding to the electronic papers 41 to 44 from the display device information memory 110, that is, the identification position information stored in the identification position table 113. Then the dividing unit 162 specifies sides that are adjacent to other partial display data, out of the sides of the partial display data. Then the dividing unit 162 adds the identification information to the specified sides based on the acquired identification position information.

At step S17, the dividing unit 162 outputs the plurality of partial display data obtained at step S16, to the display data output unit 170. The display data output unit 170 selects electronic papers as many as the number of partial display data, from among the electronic papers 41 to 44. Then the display data output unit 170 outputs the partial display data to the selected electronic papers.

As described above, the input receiving unit 150 displays an entry screen on the display 104. When the user fills out the entry screen, the display data creating unit 160 develops content specified by the user inputs, thereby creating display data. In addition, the display data creating unit 160 divides the display data into a plurality of partial display data as many as the number of electronic papers specified by the user inputs, and adds identification information to adjacent sides of adjacent partial display data. After that, the display data output unit 170 outputs the partial display data to at least some of the electronic papers 41 to 44.

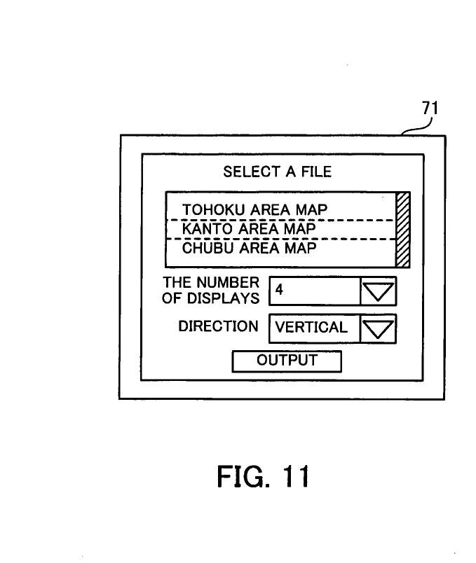

FIG. 11 shows an explanatory entry screen to be displayed on a mobile telephone. The screen 71 of FIG. 11 is an entry screen displayed on the display 104 at the above step S11. The screen 71 has a box for selecting one file to be displayed, a box for specifying the number of electronic papers to be used, and a box for specifying a display direction. In addition, the screen 71 has a bottom for fixing inputs. The user can display desired content on at least some of the electronic papers 41 to 44 by selecting a file name, the number of electronic papers, and a display direction and pressing the bottom.

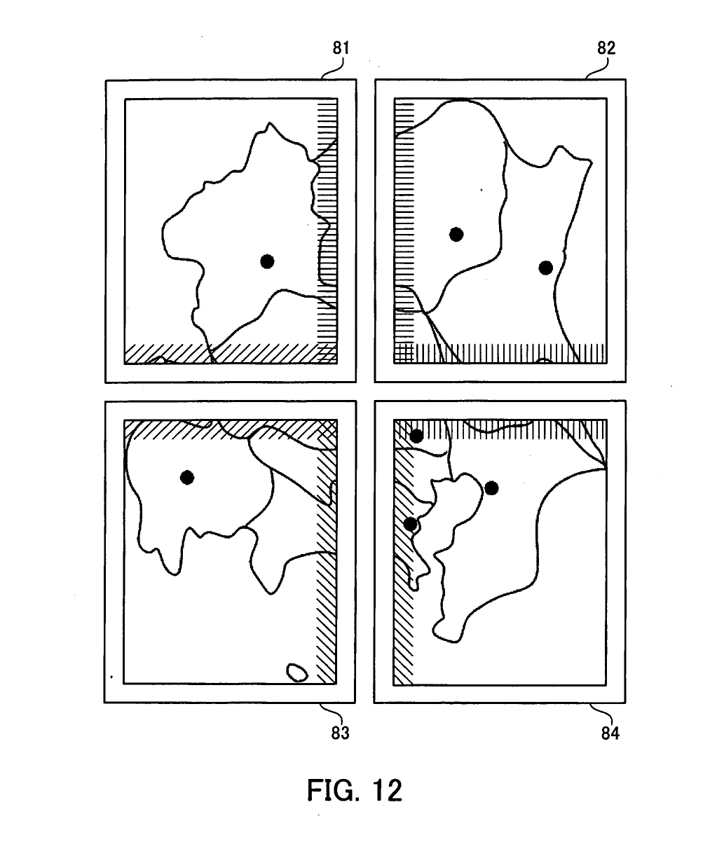

FIG. 12 shows example display screens of electronic papers according to the first embodiment. When “Kanto area map” as a file name, four as the number of electronic papers, and a vertical direction as a display direction are specified on the screen 71, the screens 81 to 84 of FIG. 12 are displayed on the electronic papers 41 to 44, respectively.

As shown in FIG. 12, the Kanto area map is divided into four and is displayed on the electronic papers 41 to 44. In this connection, identification information is displayed at adjacent sides of adjacent electronic papers out of the electronic papers 41 to 44 set in correct arrangement.

Specifically, the adjacent sides of the electronic papers 41 and 42 are colored in red. The adjacent sides of the electronic papers 41 and 43 are colored in yellow. The adjacent sides of the electronic papers 42 and 44 are colored in green. The adjacent sides of the electronic papers 43 and 44 are colored in blue. It should be noted that FIG. 12 illustrates such sides with patterns instead of colors.

By using such a mobile telephone, content can be acquired via a network, and can be divided and displayed on a plurality of electronic papers. In addition, in the case where the user carries electronic papers displaying content and views the content by arranging the electronic papers at another location, the user can easily know the correct arrangement of the electronic papers based on the displayed identification information. This greatly reduces the load in correctly arranging the plurality of electronic papers.

### Second Embodiment

Now the second embodiment will be described. The second embodiment realizes outputting partial display data one by one in the case where only one electronic paper is connectable to a mobile telephone. Different features from the above-described first embodiment will be mainly described, and explanation on same features will not be repeated.

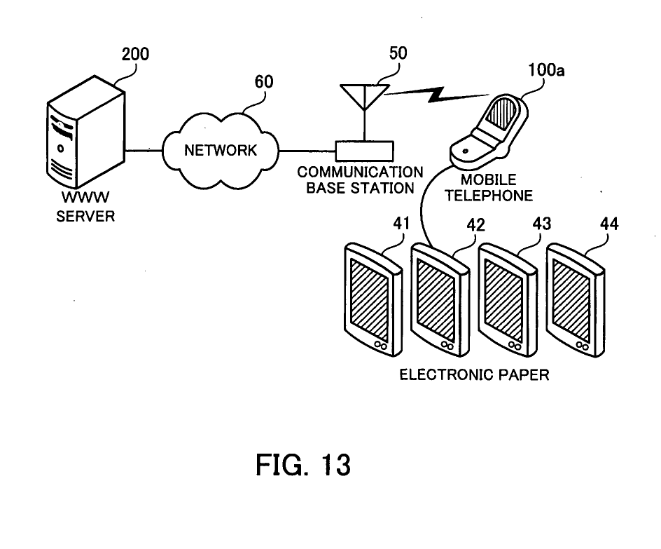

FIG. 13 shows a system configuration according to the second embodiment. A content distribution system shown in FIG. 13 comprises a mobile telephone 100a, a WWW server 200, electronic papers 41 to 44, a communication base station 50, and a network 60. The functions of the WWW server 200, the electronic papers 41 to 44, the communication base station 50, and the network 60 are the same as those of the first embodiment.

The mobile telephone 100a has an input unit, a small display unit, and an antenna for performing radio communications. In addition, the mobile telephone 100a has functions that general computers have, so as to execute prescribed programs. However, unlike the mobile telephone 100 of the first embodiment, the adaptor 30 cannot be connected to the mobile telephone 100a. One electronic paper is connectable to the mobile telephone 100a with a communication cable. Therefore, a user has to sequentially change electronic papers to be connected to the mobile telephone 100a one after another, in order to output partial display data one by one.

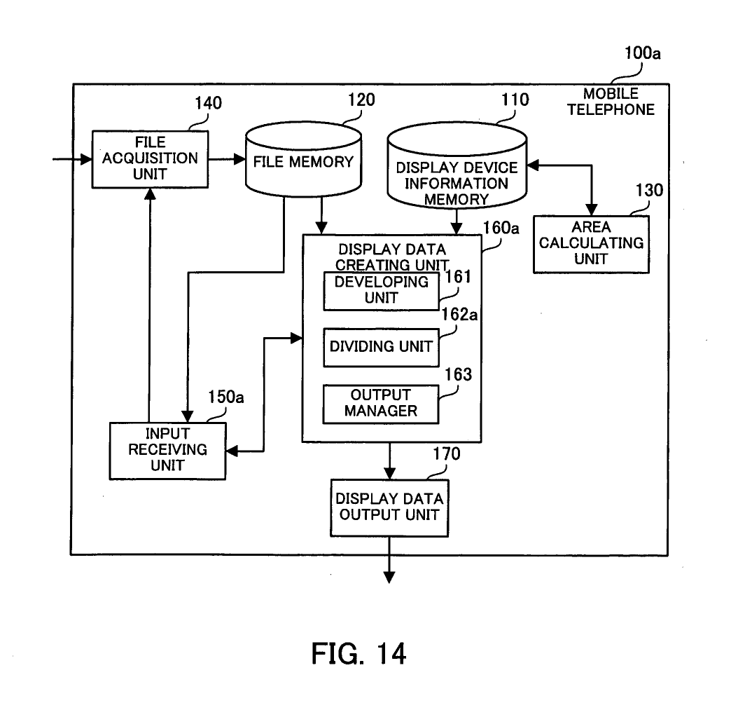

FIG. 14 is a functional block diagram of a mobile telephone according to the second embodiment. The mobile telephone 100a realizes the functional modules shown in FIG. 14 by executing programs acquired from the WWW server 200. It should be noted that FIG. 14 does not illustrate functions other than functions relating to display control that the mobile telephone 100 has.

The mobile telephone 100a has a display device information memory 110, a file memory 120, an area calculating unit 130, a file acquisition unit 140, an input receiving unit 150a, a display data creating unit 160a, and a display data output unit 170. The display device information memory 110, the file memory 120, the area calculating unit 130, the file acquisition unit 140, and the display data output unit 170 have the same processing functions as those of the first embodiment.

The input receiving unit 150a detects user inputs made on the keypad 105. If the user inputs request acquisition of a file, the input receiving unit 150a instructs the file acquisition unit 140 to acquire the file. If the user inputs request display control of the electronic papers 41 to 44, the input receiving unit 150a displays an entry screen on the display 104. Then, when the user fills out the entry screen, the input receiving unit 150a gives the contents of the user inputs to the display data creating unit 160a.

On the other hand, if the input receiving unit 150a receives an inquiry regarding partial display data to be output next, from the display data creating unit 160a, it displays a selection screen on the display 104. The selection screen is a screen for letting the user select partial display data to be output to a currently connected electronic paper. When the user selects one piece of partial display data on the selection screen, the input receiving unit 150a notifies the display data creating unit 160a of the selected partial display data.

The display data creating unit 160a has a developing unit 161, a dividing unit 162a, and an output manager 163 as internal circuits. The display data creating unit 160a instructs the developing unit 161, the dividing unit 162a, and the output manager 163 to create display data to be displayed on the electronic papers 41 to 44, according to the input contents given from the input receiving unit 150a. The developing unit 161 has the same functions as that of the first embodiment.

The dividing unit 162a divides the display data created by the developing unit 161 into a plurality of partial display data. Then the dividing unit 162a adds one piece of identification information to a side that is adjacent to another partial display data, out of the sides of the partial display data, based on identification position information stored in the display device information memory 110. It should be noted that the dividing unit 162a does not immediately output the obtained partial display data to the display data output unit 170 but keeps it.

When the dividing unit 162a creates the plurality of partial display data, the output manager 163 issues an inquiry regarding partial display data to be output first, to the input receiving unit 150a. Then the output manager 163 outputs selected partial display data to the display data output unit 170 according to a response from the input receiving unit 150a. In addition, if there is partial display data that has not been output, the output manager 163 issues an inquiry regarding partial display data to be output next, to the input receiving unit 150a. The output manager 163 repeats the above process until all of the partial display data is output.

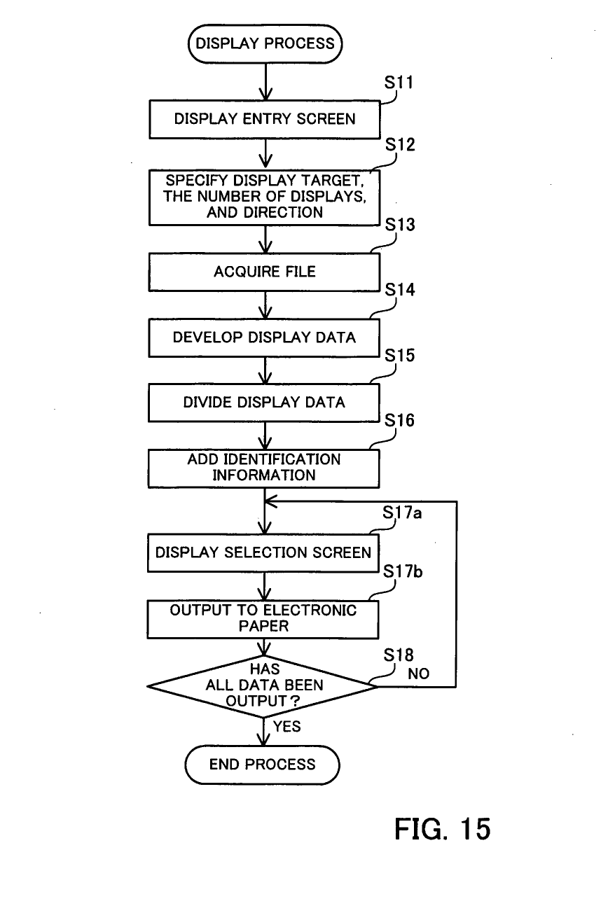

FIG. 15 is a flowchart showing a procedure of a display process according to the second embodiment. The procedure of FIG. 15 will be described step by step.

At step S11, the input receiving unit 150a acquires a list of stored files from the file memory 120. Then the input receiving unit 150a displays an entry screen on the display 104.

At step S12, the input receiving unit 150a receives user inputs made on the entry screen displayed at step S11, and specifies a file name, the number of electronic papers, and a display direction. Then the input receiving unit 150a gives the specified contents to the display data creating unit 160a.

At step S13, the display data creating unit 160a instructs the developing unit 161 to create display data. The developing unit 161 acquires a file corresponding to the file name given from the input receiving unit 150a, from the file memory 120.

At step S14, the developing unit 161 acquires the display area information of the electronic papers 41 to 44 from the display area table 111. Then the developing unit 161 specifies the entire usable display area based on the display area information, the number of electronic papers to be used, and the display direction. Then the developing unit 161 develops the content so as to match the specified entire display area, thereby creating display data.

At step S15, the display data creating unit 160a instructs the dividing unit 162a to divide the display data. The dividing unit 162a divides the display data created by the developing unit 161 into a plurality of partial display data.

At step S16, the dividing unit 162a acquires identification position information corresponding to the electronic papers 41 to 44 from the display device information memory 110. Then the dividing unit 162a adds identification information to sides that are adjacent to other partial display data, out of the sides of the partial display data. Then the dividing unit 162a instructs the output manger 163 to sequentially output the partial display data.

At step S17a, the output manager 163 issues an inquiry regarding partial display data to be output, to the input receiving unit 150a. The input receiving unit 15a displays a selection screen on the display 104.

At step S17b, the input receiving unit 150a detects user inputs made on the selection screen, and notifies the display data creating unit 160a of the selected partial display data. The output manager 163 outputs the partial display data notified of from the input receiving unit 150a to the display data output unit 170. The display data output unit 170 outputs the received partial display data to the connected electronic paper.

At step S18, the output manager 163 determines whether all of the partial display data have been output. If all of the partial display data have been output, the display process is completed. If there is partial display data that has not been output, the procedure goes back to step S17a.

As described above, the input receiving unit 150a displays an entry screen on the display 104. If the user fills out the entry screen, the display data creating unit 160a develops content specified by the user inputs to thereby create display data. In addition, the display data creating unit 160a divides the display data into a plurality of partial display data according to the number of electronic papers specified by the user inputs, and also adds identification information to adjacent sides of adjacent partial display data. Then the display data output unit 170 outputs the partial display data one by one to electronic papers connected.

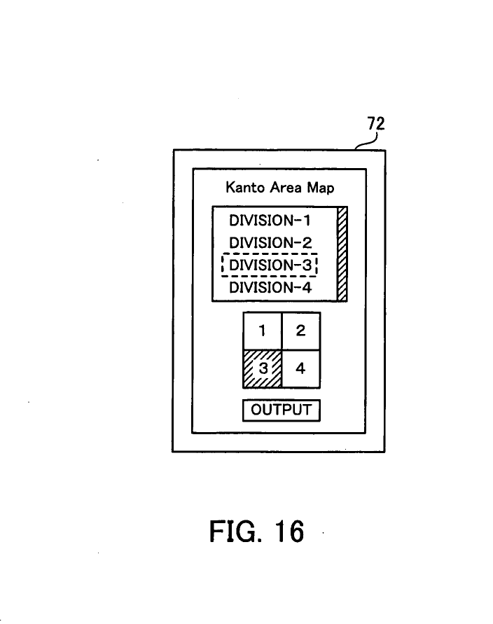

FIG. 16 shows an explanatory output process screen to be displayed on a mobile telephone. The screen 72 shown in FIG. 16 is a screen that is displayed on the display 104 at the above step S17a. The screen 72 has a selection box displaying a list of partial display data and a button for fixing selection of partial display data to be output next. The user connects another electronic paper to the mobile telephone 100a, and then selects one piece of partial display data and presses the button on the screen 72. Thereby the selected partial display data is output to the connected electronic paper.

With such a mobile telephone, content can be acquired via the network, and can be divided and displayed on a plurality of electronic papers. In addition, if the user wants to carry a plurality of electronic papers displaying content and see the content by arranging the electronic papers at another location, he/she can easily know the correct arrangement based on the displayed identification information. This can greatly reduce the load in correctly arranging a plurality of electronic papers. Further, even if only one electronic paper is connectable, partial display data can be sequentially output one by one to the plurality of electronic papers.

In the second embodiment, only one electronic paper is connectable to a mobile telephone at the same time. However, it can be designed that two or more electronic papers are connectable at the same time. For example, two electronic papers are connected at the same time and the mobile telephone can output partial display data two by two. In addition, the mobile telephone can be designed to automatically detect the number of electronic papers connectable at the same time, and adjust the number of partial display data to be output at the same time.

### Third Embodiment

Now, the third embodiment will be described. The third embodiment uses letters as identification information and displays the correct arrangement of electronic papers with corresponding identification information on the display of a mobile telephone. Only different features from the above-described first embodiment will be described and explanation on same features will not be repeated.

The system configuration according to the third embodiment is the same as that of the first embodiment shown in FIG. 2. However, some of the processing functions that are realized by a mobile telephone executing a display control program are different from those of the first embodiment. In the following description, it is assumed that the mobile telephone 100b is a device corresponding to the mobile telephone 100 of the first embodiment.

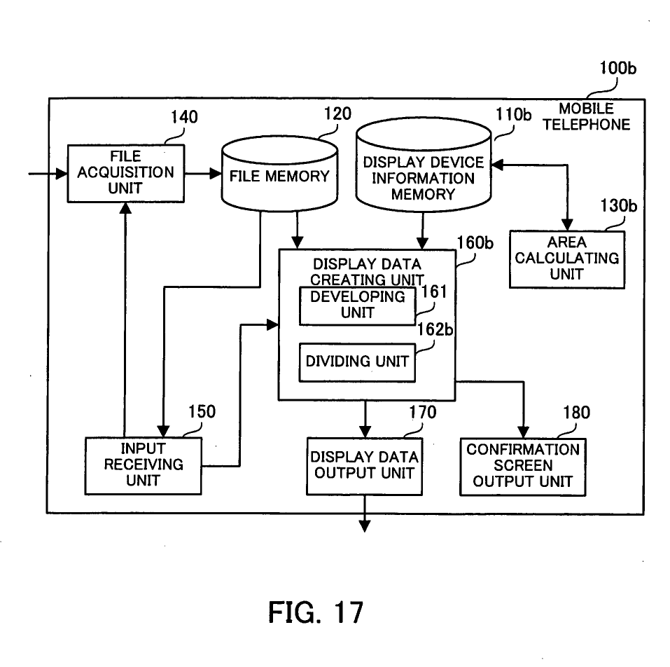

FIG. 17 is a functional block diagram of a mobile telephone according to the third embodiment. The mobile telephone 100b realizes functional modules shown in FIG. 17 by executing programs acquired from a WWW server 200. It should be noted that FIG. 17 does not illustrate functions other than functions relating to display control that the mobile telephone 100b has.

The mobile telephone 100b has a display device information memory 110b, a file memory 120, an area calculating unit 130b, a file acquisition unit 140, an input receiving unit 150, a display data creating unit 160b, a display data output unit 170, and a confirmation screen output unit 180. The processing functions of the file memory 120, the file acquisition unit 140, the input receiving unit 150, and the display data output unit 170 are the same as those of the first embodiment.

The display device information memory 110b stores the display area information of electronic papers that may be connected to the mobile telephone 100b. For example, the same table as the display area table 111 of FIG. 6 is stored in advance. In addition, the display device information memory 110b stores identification position information associating identification information with display positions. In this third embodiment, the identification information is added to corners of partial display data, not sides thereof. In addition, letters are used as identification information. The identification position information is created by the area calculating unit 130b.

The area calculating unit 130b first confirms the types of electronic papers currently connected to the mobile telephone 100b when a display control program is started. Then the area calculating unit 130b searches the display device information memory 110b for identification position information corresponding to the connected electronic papers. If such identification position information is not found, the area calculating unit 130b creates identification position information based on the display area information of the connected electronic papers and stores it in the display device information memory 110b.

The display data creating unit 160b has a developing unit 161 and a dividing unit 162b as internal circuits. The display data creating unit 160b instructs the developing unit 161 and the dividing unit 162b to create display data to be displayed on the electronic papers 41 to 44, according to input contents given from the input receiving unit 150. The developing unit 161 has the same processing function as that of the first embodiment.

The dividing unit 162b divides the display data created by the developing unit 161, into a plurality of partial display data based on the number of electronic papers to be used and the display area information stored in the display device information memory lob. Then the dividing unit 162b adds one piece of identification information to a corner that is adjacent to other partial display data, out of the corners of the partial display data, based on the identification position information stored in the display device information memory 110b.

Further, the dividing unit 162b creates and outputs confirmation screen data to the confirmation screen output unit 180. The confirmation screen is a screen that displays the positional relationships among a plurality of partial display data in association with the identification information. Then the dividing unit 162b outputs the obtained plurality of partial display data to the display data output unit 170.

When the display data creating unit 160b outputs the confirmation screen data, the confirmation screen output unit 180 displays the confirmation screen on the display 104 based on the received confirmation screen data.

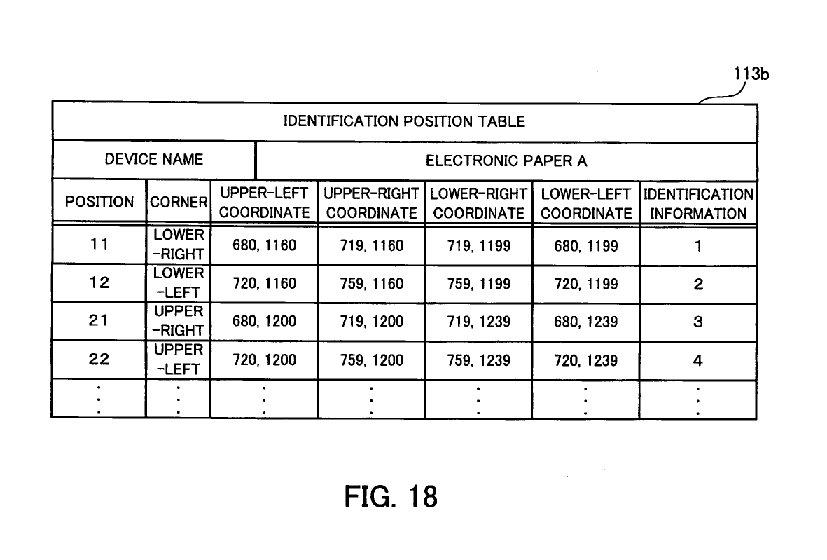

FIG. 18 shows an explanatory data structure of an identification position table according to the third embodiment. The identification position table 113b shown in FIG. 18 is a table storing the identification position information of an electronic paper of type named “electronic paper A”. The identification position table 113b corresponds to the identification position table 113 of the first embodiment shown in FIG. 9. The identification position table 113b is stored in the display device information memory 110b.

The identification position table 113b has columns for position, corner, upper-left coordinate, upper-right coordinate, lower-right coordinate, lower-left coordinate, and identification information. Information arranged in a row is associated with each other to compose identification position information.

The position column shows a numerical value indicating the position of partial display data in an entire display area. The numerical value indicating a position comprises a two-digit integral number showing a horizontal position and a vertical position with the upper left of the entire display area as a reference point.

The corner column shows letters indicating a corner to which identification information is added. Specifically, one of “upper-left”, “upper-right”, “lower-right”, and “lower-left” is set.

The upper-left coordinate column shows numerical values indicating the coordinate of the upper-left point of a region to which identification information is added.

The upper-right coordinate column shows numerical values indicating the coordinate of the upper-right point of a region to which identification information is added. The lower-right coordinate column shows numerical values indicating the coordinate of the lower-right point of a region to which identification information is added. The lower-left coordinate column shows numerical values indicating the coordinate of the lower-left point of a region to which identification information is added.

The identification information column shows identification information to be added to a region specified by the other columns. In the example of FIG. 18, continuous values starting with “1” are set.

Identification position information to be stored in the identification position table 113b is registered by the area calculating unit 113b when the display control program is started. For example, information comprising a position of “11”, a corner of “lower-right”, an upper-left coordinate of “680, 1160”, an upper-right coordinate of “719, 1160”, a lower-right coordinate of “719, 1199”, a lower-left coordinate of “680, 1199”, and identification information of “1” is registered. This means that a number “1” is displayed at a lower-right corner of 40-pixel square.

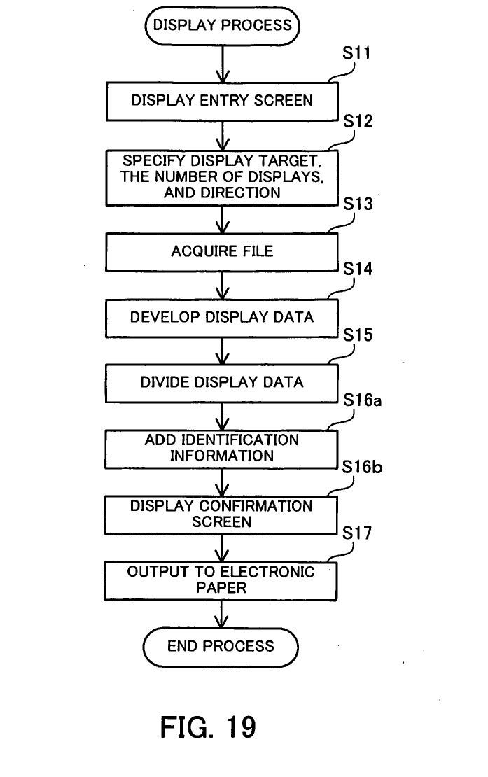

FIG. 19 is a flowchart showing a procedure of a display process according to the third embodiment. The procedure of FIG. 19 will be described step by step.

At step S11, the input receiving unit 150 acquires a list of stored files from the file memory 120. The input receiving unit 150 displays an entry screen on the display 104.

At step S12, the input receiving unit 150 receives user inputs made on the entry screen displayed at step S11, and specifies a file name, the number of electronic papers, and a display direction. Then the input receiving unit 150 gives the specified contents to the display data creating unit 160b.

At step S13, the display data creating unit 160b instructs the developing unit 161 to create display data. The developing unit 161 acquires a file corresponding to the file name given from the input receiving unit 150, from the file memory 120.

At step S14, the developing unit 161 acquires the display area information of the electronic papers 41 to 44 from the display area table 111. Then the developing unit 161 specifies the entire usable display area based on the display area information, the number of electronic papers to be used, and the display direction. Then the developing unit 161 develops the content so as to match the specified entire display area, thereby creating the display data.

At step S15, the display data creating unit 160b instructs the dividing unit 162b to divide the display data. The dividing unit 162b divides the display data created by the developing unit 161 into a plurality of partial display data.

At step S16a, the dividing unit 162b acquires identification position information corresponding to the electronic papers 41 to 44 from the display device information memory 110b. Then the dividing unit 162b adds identification information to corners that are adjacent to other partial display data, out of the corners of the partial display data.

At step S16b, the dividing unit 162b creates confirmation screen data for displaying the identification information added at step S16b in association with the positional relationships among the partial display data. Then the dividing unit 162b outputs the created confirmation screen data to the confirmation screen output unit 180. The confirmation screen output unit 180 displays a confirmation screen on the display 104 based on the received confirmation screen data.

At step S17, the dividing unit 162b outputs the plurality of partial display data obtained at step S16a to the display data output unit 170. The display data output unit 170 selects electronic papers as many as the number of partial display data, from among the electronic papers 41 to 44, and outputs the partial display data to the selected electronic papers.

As described above, the input receiving unit 150 displays an entry screen on the display 104. When the user fills out the entry screen, the display data creating unit 160b creates display data by developing content specified by the user inputs. In addition, the display data creating unit 160b divides the display data into a plurality of partial display data according to the number of electronic papers specified by the user inputs, and adds identification information to corners that are adjacent to other partial display data.

After that, the confirmation screen output unit 180 displays a confirmation screen on the display 104. In addition, the display data output unit 170 outputs the partial display data to the connected electronic papers.

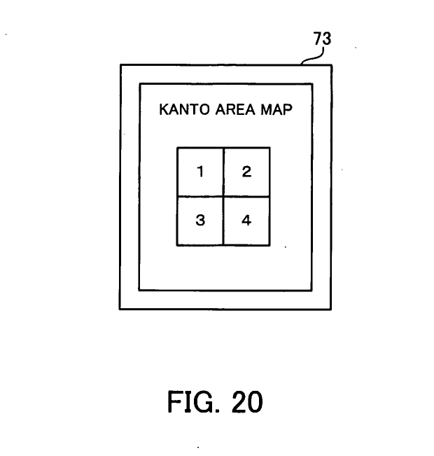

FIG. 20 shows an explanatory position confirmation screen to be displayed on a mobile telephone. The screen 73 shown in FIG. 20 is a screen to be displayed on the display 104 at the above step S16a. The screen 73 shown in FIG. 20 shows that the display data is divided into four pieces of partial display data. In addition, the screen shows that “1”, “2”, “3”, and “4” are added to the upper-left partial display data, the upper-right partial display data, the lower-left partial display data, and the lower-right partial display data, respectively.

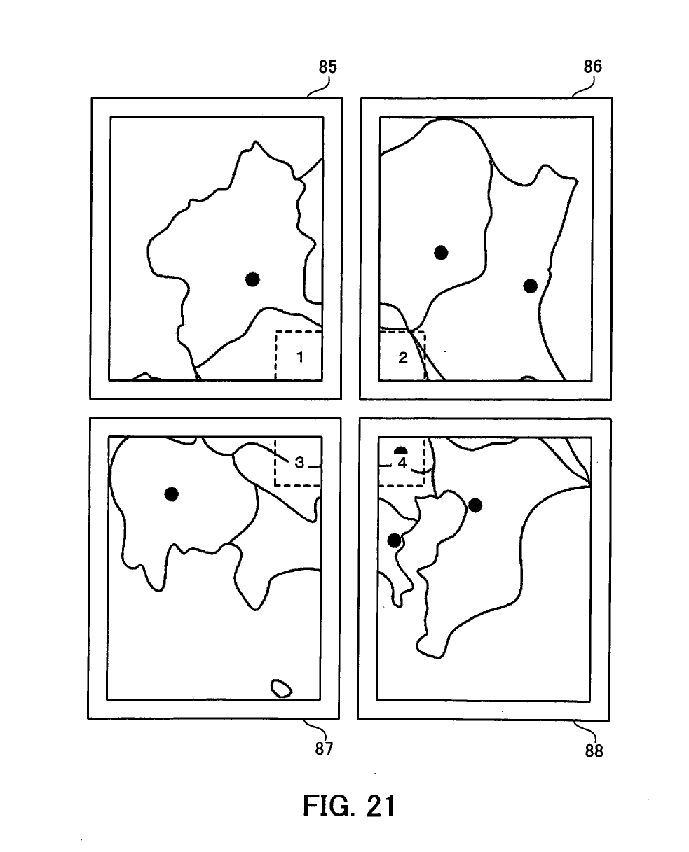

FIG. 21 shows example display screens of electronic papers according to the third embodiment. The screens 85 to 88 shown in FIG. 21 are screens to be displayed on the electronic papers 41 to 44, respectively, at the above step S17. FIG. 21 shows a Kanto area map divided into four and displayed on the electronic papers 41 to 44. In addition, identification information is displayed at corners that are adjacent to other electronic papers, out of the corners of the electronic papers 41 to 44 set in correct arrangement.

Specifically, “1”, “2”, “3”, and “4” are displayed at the lower-right corner of the electronic paper 41, the lower-left corner of the electronic paper 42, the upper-right corner of the electronic paper 43, the upper-left corner of the electronic paper 44, respectively.

It should be noted that identification information is added at only a central part of the entire display data in FIG. 21. However, identification information is added to other corners if more electronic papers are used. For example, three electronic papers horizontally and vertically, that is, nine electronic papers are used, identification information is added to the lower-right corner of the screen 86, the lower-right corner of the screen 87, and the lower-left, upper-right and lower-right corners of the screen 88 as well.

With such a mobile telephone, content can be acquired via the network, and can be divided and displayed on a plurality of electronic papers. In addition, if a user wants to carry the electronic papers displaying the content, and to view the content by arranging the electronic papers at another location, he/she can know the correct arrangement of the electronic papers based on the displayed identification information. This greatly reduces the load in correctly arranging the plurality of electronic papers.

Especially, adding identification information to corners that are adjacent to other electronic papers allows the correct arrangement to be recognized easily. In addition, displaying a screen showing identification information and the positional relationships among electronic papers in association with each other on the display of the mobile telephone allows the correct arrangement of the electronic papers to be recognized easily even if many electronic papers are used.

It should be noted that the above-described embodiments use a mobile telephone as a device for controlling content to be displayed on electronic papers. However, other kinds of mobile terminal devices such as PDAs and Laptop computers can be used instead. In addition, the above-described embodiments have been described for display control of electronic papers. However, these can be applied for display control of other kinds of display devices such as liquid crystal displays and projectors.

Further, in the above embodiments, the used electronic papers have the same display area size for simple explanation. However, electronic papers having different display area sizes can be used together. Furthermore, in the above embodiments, the electronic papers are used in the same display direction. However, some of the electronic papers can be specified as being used in a vertical display direction, and the others in a horizontal display direction.

Furthermore, in the above embodiments, identification information specifying a position to which identification information is to be added is created by the mobile telephone. However, such identification information can be created by a WWW server.

Furthermore, it is easy to combine the first to third embodiments. For example, it can be considered to use colors or patterns used in the first embodiment as identification information in the third embodiment instead of letters. In addition, it can be considered to sequentially output a plurality of partial display data one by one as taught in the second embodiment, in the third embodiment instead of outputting the plurality of partial display data at the same time.

The processing functions described above can be realized by a computer. In this case, a program is prepared, which describes processes for the functions to be performed by the mobile telephones 100, 100a, and 100b. The program is executed by a computer, whereupon the aforementioned processing functions are accomplished by the computer. The program describing the required processes may be recorded on a computer-readable recording medium. Computer-readable recording media include magnetic recording devices, optical discs, magneto-optical recording media, semiconductor memories, etc. The magnetic recording devices include Hard Disk Drives (HDD), Flexible Disks (FD), magnetic tapes (MT), etc. The optical discs include Digital Versatile Discs (DVDs), DVD-RAM, CD-ROM, CD-R (Recordable)/RW (ReWritable), etc. The magneto-optical recording media include MO (Magneto-Optical disk) etc.

To distribute the program, portable recording media, such as DVDs and CD-ROMs, on which the program is recorded may be put on sale. Alternatively, the program may be stored in the storage device of a server computer and may be transferred from the server computer to other computers through a network.

A computer which is to execute the program stores in its storage device the program recorded on a portable recording medium or transferred from the server computer, for example. Then, the computer runs the program. The computer may run the program directly from the portable recording medium. Also, while receiving the program being transferred from the server computer, the computer may sequentially run this program.

According to the present invention, display data is divided into a plurality of partial display data, and identification information is added to sides that are adjacent to other partial display data and is output to display devices. This can allow a user to easily recognize the adjacent relationships among the display devices.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium containing a display control program for displaying content on a plurality of display devices, the display control program causing a computer to operate as:
an area information memory storing information on display areas of the plurality of display devices;
an identification information memory storing a plurality of identification information;
a creating unit for consulting the area information memory to specify an entire usable display area and creating display data so as to match the entire usable display area when information specifying a number of display devices to be used and content to be displayed is entered;
a dividing unit for dividing the display data created by the creating unit into a plurality of partial display data according to the display areas of the display devices and adding one of the plurality of identification information stored in the identification information memory, to a side of partial display data out of sides of the plurality of partial display data, the side adjacent to another partial display data; and
an output unit for outputting the plurality of partial display data obtained by the dividing unit, to the display devices.

2. The computer-readable recording medium according to claim 1, wherein the dividing unit selects identification information in such a manner that same identification information is added to the side of the partial display data and another side of the another partial display data which are adjacent to each other and the same identification information is not added to sides which are not adjacent to each other.

3. The computer-readable recording medium according to claim 1, wherein, if a number of display devices connected to the computer is fewer than the number of display devices to be used, the output unit outputs the is partial display data as many as the number of display devices connected, and when the display devices connected are changed, the output unit outputs other partial display data that have not been output.

4. The computer-readable recording medium according to claim 1, the display control program further causing the computer to operate as a confirmation display unit for outputting confirmation display data to a prescribed display device different from the display devices to be used for displaying the content, the confirmation display data showing correspondences between the identification information used by the dividing unit and the plurality of partial display data.

5. A computer-readable recording medium containing a display control program for displaying content on a plurality of display devices, the display control program causing a computer to operate as:
an area information memory storing information on display areas of the plurality of display devices;
an identification information memory storing a plurality of identification information;
a creating unit for consulting the area information memory to specify an entire usable display area and creating display data so as to match the entire usable display area when information specifying a number of display devices to be used and content to be displayed is entered;
a dividing unit for dividing the display data created by the creating unit into a plurality of partial display data according to the display areas of the display devices and adding one of the plurality of identification information stored in the identification information memory, to a corner of partial display data out of corners of the plurality of partial display data, the corner sandwiched between two other pieces of partial display data; and
an output unit for outputting the plurality of partial display data obtained by the dividing unit, to the display devices.

6. The computer-readable recording medium according to claim 5, wherein if a number of display devices connected to the computer is fewer than the number of display devices to be used, the output unit outputs the partial display data as many as the number of display devices connected, and when the display devices connected are changed, the output unit outputs other partial display data that have not been output.

7. The computer-readable recording medium according to claim 5, further causing the computer to operate as a confirmation display unit for outputting confirmation display data to a prescribed display device different from the display devices to be used for displaying the content, the confirmation display data showing correspondences between the identification information used by the dividing unit and the plurality of partial display data.

8. A display control apparatus for displaying content on a plurality of display devices, comprising:
area information memory means storing information on display areas of the plurality of display devices;
identification information memory means storing a plurality of identification information;
creating means that consults the area information memory means to specify an entire usable display area and creates display data so as to match the entire usable display area when information specifying a number of display devices to be used and content to be displayed is entered;
dividing means that divides the display data created by the creating means into a plurality of partial display data according to the display areas of the display devices and adds one of the plurality of identification information stored in the identification information memory means, to a side of partial display data out of sides of the plurality of partial display data, the side adjacent to another partial display data; and
output means that outputs the partial display data obtained by the dividing means to the display devices.

9. The display control apparatus according to claim 8, wherein the dividing means selects identification information in such a manner that same identification information is added to the side of the partial display data and another side of the another partial display data which are adjacent to each other and the same identification information is not added to sides which are not adjacent to each other.

10. The display control apparatus according to claim 8, wherein, if a number of display devices connected to the display control apparatus is fewer than the number of display devices to be used, the output means outputs the partial display data as many as the number of display devices connected, and when the display devices connected are changed, the output means outputs other partial display data that have not been output.

11. The display control apparatus according to claim 8, further comprising confirmation display means that outputs confirmation display data to a prescribed display device different from the display devices to be used for displaying the content, the confirmation display data showing correspondences between the identification information used by the dividing means and the plurality of partial display data.

12. A display control apparatus for displaying content on a plurality of display devices, comprising:
area information memory means storing information on display areas of the plurality of display devices;
identification information memory means storing a plurality of identification information;
creating means that consults the area information memory means to specify an entire usable display area and creates display data so as to match the entire usable display area when information specifying a number of display devices to be used and content to be displayed is entered;
dividing means that divides the display data created by the creating means into a plurality of partial display data according to the display areas of the display devices and adds one of the plurality of identification information stored in the identification information memory means, to a corner of partial display data out of corners of the plurality of partial display data, the corner sandwiched between two other pieces of partial display data; and
output means that outputs the plurality of partial display data obtained by the dividing means, to the display devices.

13. The display control apparatus according to claim 12, wherein, if a number of display devices connected to the display control apparatus is fewer than the number of display devices to be used, the output means outputs the partial display data as many as the number of display devices connected, and when the display devices connected are changed, the output means outputs other partial display data that have not been output.

14. The display control apparatus according to claim 12, further comprising confirmation display means that outputs confirmation display data to a prescribed display device different from the display devices to be used for displaying the content, the confirmation display data showing correspondences between the identification information used by the dividing means and the plurality of partial display data.
